(19) United States
(12) Patent Application Publication
(10) Pub. No.: US 2026/0287470 A1
(43) Pub. Date: Sep. 24, 2026

(54) System and Method for Distinguishing Lubrication Faults from Mechanical Faults in the Bearings or Gears of Rotating Machinery

(71) Applicant: U.E. Systems, Inc., Elmsford, NY (US)

(72) Inventors: Blair Fraser, Cambridge (CA); William Bishop, Pleasantville, NY (US); Tomasz Barszcz, Brzozowka (PL)

(73) Assignee: U.E. Systems, Inc., Elmsford, NY (US)

(21) Appl. No.: 19/088,848

(22) Filed: Mar. 24, 2025

(51) Int. Cl. G01M 13/045; G01M 13/028

(52) U.S. Cl. CPC G01M 13/045; G01M 13/028

(57) ABSTRACT

A method and system for distinguishing lubrication faults from mechanical faults in rotary machinery using ultrasound analysis. Ultrasonic signals or ultrasound data is received from the machinery. The Zero-Peak and RMS values of the signals are detected to identify whether any fault is presence. If so, the system calculates an envelope spectrum of the ultrasound data; and classifies the fault as a lubrication or mechanical fault based on periodicity indicated within a low-frequency band of the envelope spectrum.

### FIELD OF THE INVENTION

The present invention relates to the detection of faults in the bearings or gears of rotating machinery and, more particularly, to distinguishing between lubrication and mechanical faults through the analysis of the spectrum of ultrasonic signals emitted by the bearings or gears.

### BACKGROUND OF THE INVENTION

Industrial machinery often relies on monitoring the status of the machinery to detect faults in critical components like bearings and gears. It has been common for some time to detect faults in the bearings of rotating machinery by sensing the ultrasonic signals emitted by the bearings during high-speed rotation. For example, see U.S. Pat. Nos. 8,707,785; 9,200,979 and 10,634,650 of Goodman et al. (assignors to UE Systems of New York), which are incorporated herein by reference in their entirety. The early systems used the peak-to-peak or zero-to-peak amplitude or the RMS value of the ultrasonic signal as a measure of a fault condition. When the amplitude or RMS value exceeded a certain level, it was predicted that a fault had occurred.

Bearings have two major types of faults that can cause elevated levels of ultrasound, i.e., lack of lubrication and bearing wear. The typical response to an elevated ultrasound signal is to apply lubrication to the bearing as indicated in the patents listed above. In one embodiment, the lubrication is applied by a maintenance worker walking up to the machines and injecting lubricant into the bearings. However, in large plants with multiple machines, this can prove to be time consuming and costly. More recently it has been proposed, e.g., in U.S. Pat. No. 12,007,760 of Bishop et al. (assignor to UE Systems), which is incorporated herein by reference in its entirety, that lubrication systems be connected to the bearings and that these systems be remotely operated, either when the ultrasonic signal or an alarm signal based on the magnitude of the ultrasonic signal is transmitted to a central location. At the central location an operator can activate the lubrication system at the bearing to provide enough lubricant to cause the ultrasonic signal to decrease below the measurement threshold. In some systems this remote lubrication is performed automatically from a location remote from the plant where the machinery is located or even at great distances using cloud-based systems.

Many of the ultrasonic detection systems mentioned above, in addition to looking at the peak-to-peak or RMS amplitude, also examine the spectrum of the ultrasonic signal as a way of refining the fault detection process. For example, US Application Publication 2023-003690 of Bishop (to UE Systems), which is incorporated herein by reference in its entirety, proposes detecting the edge of the signal as an indication of when lubrication has started.

Where the reason for the elevated ultrasonic signal is bearing wear, applying lubricant is only a temporary fix. Also, applying the lubricant delays the changing of the worn bearing, which can lead to damage to the bearing, bearing shaft and even to damage to the mechanism driven by the shaft. Further, damage to such a mechanism can damage the entire machine and can injure workman in the vicinity of the machine. Thus, it can be important to distinguish early between a bearing that needs lubrication and one that needs to be replaced. Also, it would be advantageous if this distinction could be made on the basis of an analysis of the same ultrasonic signal used to detect a need for lubrication.

However, existing ultrasound diagnostic methods struggle to effectively differentiate between lubrication faults and mechanical faults using a single RMS value. They often require expertise in analysing time series and frequency spectrum data. For example, U.S. Pat. No. 9,200,979 mentioned above discloses the use of software to automatically analyze the Fast Fourier Transform (FFT) spectrum of the ultrasonic signal by comparing the current spectrum with stored spectrums of known bearing conditions as modified based on the rotary speed of the bearing and the number of bearing balls. In particular, a fault in one of the balls of a bearing is detected by spikes in the spectrum at frequencies related to the speed of rotation and the number of balls. Also, a number of prior art systems suggest using machine learning where a model is trained on the vibration spectrum from bearings with mechanical faults so that it can recognize the fault in a bearing under test. See for example, CN112364762 of Nanjing University, which relies on machine learning model training and new data testing for mechanical transmission fault detection. See also U.S. Pat. No. 11,333,575 of Zhang et al. However, the use of machine learning is time consuming and expensive. Further it may trigger false alarms due to overlapping signal characteristics, leading to unnecessary maintenance and resource costs. In particular, during the machine learning process the user has little or no influence on which signal features and to what extent they will be selected by the machine learning algorithm to generate conclusions and alarms. It may happen that algorithm will select features from very close states (i.e. overlapping), for instance the Zero-Peak parameter for both under-lubrication and faulty bearing, which creates an imbalance, to be exact.

### SUMMARY OF THE INVENTION

The present invention addresses the need to effectively, inexpensively and quickly analyze the envelope and periodicity of the ultrasonic spectrum emitted by rotating bearings or gears to classify the type of bearing or gear faults efficiently.

By analyzing the envelope spectrum and identifying the periodic nature of fault-related signals, the system distinguishes between lubrication-related faults and mechanical faults with high accuracy. The method conserves computational resources by performing an initial fault detection based on zero-peak and RMS levels before conducting the more intensive analysis. The result is a reliable, efficient diagnostic tool suitable for embedded implementation.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1 is a block diagram of a system for carrying out the present invention;

FIG. 2 is a flow chart for the processes carried out by the present invention;

FIG. 3A is a part of the flow chart of FIG. 2 and FIG. 3B shows the spectrum of signals when the system indicates that the bearings or gears are without fault, i.e., OK;

FIG. 4 is a part of the flow chart of FIG. 2 showing the spectrum of signals when the system indicates that the bearings or gears have a low lubrication fault, i.e., UNDERLUB; and

FIG. 5 is a part of the flow chart of FIG. 2 showing the spectrum of signals when the system indicates that the bearings or gears have a mechanical fault.

### DETAILED DESCRIPTION OF THE INVENTION

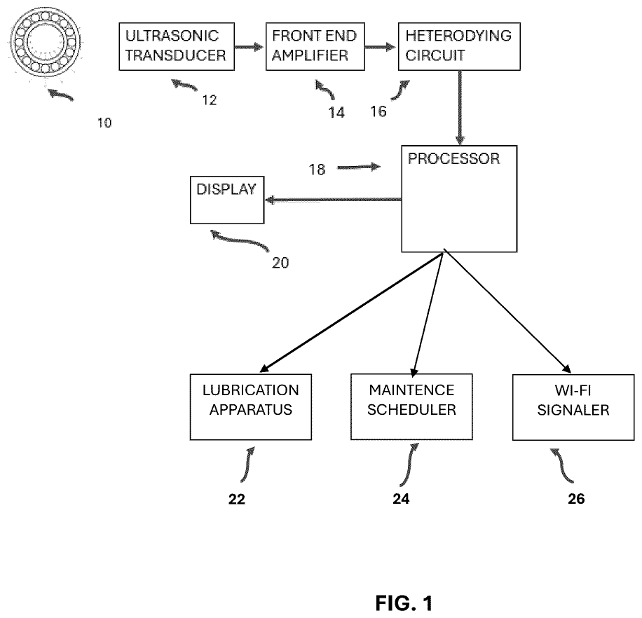

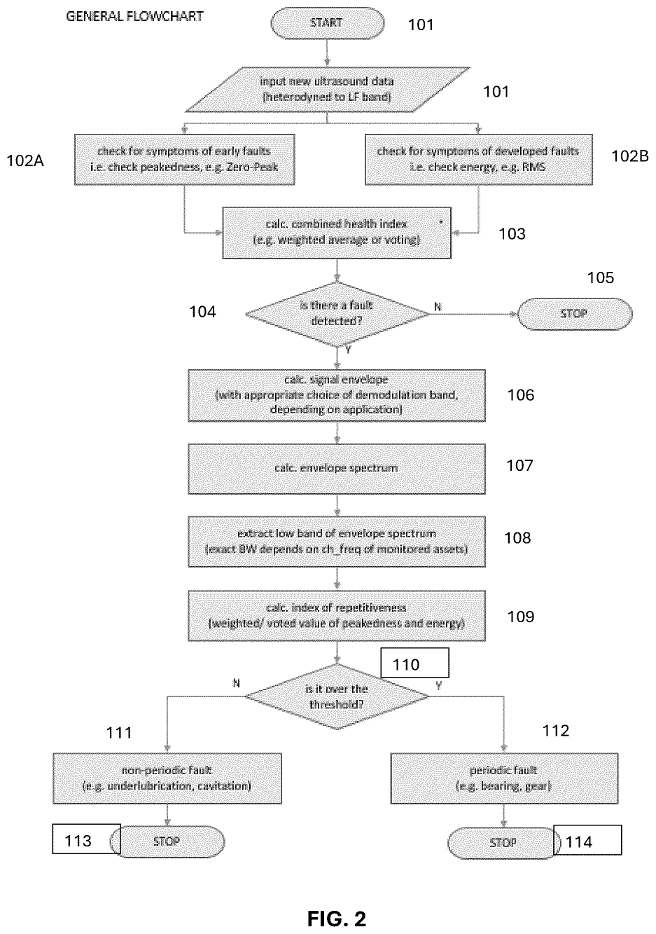

As shown in FIG. 1 the system of the present invention begins by capturing ultrasound signals or data from a source, e.g., a bearing 10. The captured signal is heterodyned (shifted) to a lower frequency (LF) band suitable for processing, e.g., the audio band. In particular, an ultrasonic transducer 12 placed in the vicinity of the rotating bearing or gear under test 10 picks up the ultrasonic signal, which may be amplified by a front-end amplifier 14. The output of the front-end amplifier is provided to a heterodyning circuit 16 that translates the signal frequency from the ultrasonic range (20 khz-50 khz) to the audio band. This heterodyning ensures compatibility with the system's analysis parameters, which are typically at a frequency lower than ultrasound, thus saving processing power.

The heterodyned signal is applied to processor 18, which analyses the signal. Initial analysis checks for early indicators of faults maybe performed by processor 18 examining the signal's Zero-to-Peak amplitude or peakedness, looking for subtle, early-stage fault signals. Another parallel analysis performed by processor 18 evaluates more advanced fault indicators by measuring the energy level of the signal, e.g., the RMS value. If either the initial or other fault symptoms are present, the system calculates a “combined health index” using a weighted average or voting mechanism between the Zero-to-Peak and RMS values, determining whether a fault is present in the data. If a fault is found, the processor's goes on to determine whether it is a mechanical fault or lubrication fault. This determination is made by reviewing the signal spectrum, including its envelope. When the envelope spectrum shows repetitiveness, the fault is determined to be a mechanical fault, otherwise it is determined to be a lubrication fault.

Ultimately the determination of no fault or the type of fault is transmitted to display 20 so the user can determine the next course of action. For example, if the system is deployed in a handheld unit carried by a mechanic and there is a low lubrication signal, the mechanic can apply lubrication. The mechanic may be instructed to provide lubrication until the ultrasonic signal is below an acceptance threshold. If a mechanical fault is detected the mechanic can replace the worn bearing or gear. If the system is remote from the machinery, and if a mechanical fault is displayed, the user may dispatch a mechanic to the site of the bearing or gear to replace it or it can be logged onto the mechanic's schedule for replacement on his next trip.. Naturally, if no fault is detected, this can be recorded, and the system can move onto the next bearing or gear to be tested.

The processor in addition to displaying a fault condition can generate commands. For example, if a bearing is equipped with a lubrication supply apparatus 22 as in U.S. Pat. No. 12,007,760, the command can automatically cause lubrication to be dispensed until the ultrasonic signal drops to an acceptable level. If the processor detects a mechanical fault, while the system cannot change or replace a bearing or gear itself, the need for the replacement of the bearing or gear can be logged to the performance tasks of the mechanic in a maintenance scheduling apparatus 24, so that it will be exchanged on the mechanic's next trip to the machinery. If the fault is in a late stage, and there is danger that the bearing will fail, a message can be sent to the mechanic, e.g., through a WiFi or Bluetooth signal apparatus 26, requesting immediate action.

Once a fault is detected, an algorithm calculates the signal envelope with an appropriate demodulation band tailored to the specific application, where the demodulation band is the frequency range used to generate the signal envelope spectrum. There are several methods known in the art to determine this range. The algorithm has to be flexible enough to be adapted to a group of machinery under test.

The envelope spectrum is then calculated, focusing on the low-frequency band, typically below 1 kHz, to reveal the periodic nature of mechanical faults like Balls Pass Frequency Outer Race (BPFO), which is a bearing fault frequency that corresponds to the number of balls or rollers that pass a specific point on the outer race of a bearing each second the shaft rotates completely. The bearing fault frequency is in shaft harmonics (sometimes noted an nX) and requires exact measurement of the rotational speed. Thresholds are set for Zero-Peak, RMS, and periodicity in order to classify detected faults as either lubrication-related (non-periodic) or mechanical (periodic). The system conserves resources by stopping the process if no fault is detected in the initial steps, and only proceeding to further analysis if a fault is indicated.

The overall operation of the processor according to the present invention is represented by the flow chart of FIG. 2. In effect, the processor can be programmed to carry out the steps of the flow chart. This processor can be any convenient type of computer. However, if the system is incorporated into a handheld detector such as shown in U.S. Pat. No. 8,707,785 of Goodman et al., a microprocessor may be preferred.

The procedure shown in FIG. 2 can be executed periodically, as new ultrasonic data is acquired or on demand. The process starts at step 100. The next step 101 is to accept new ultrasound data from transducer 12 and to heterodyne it with circuit 16 to the audio or low frequency (LF) band. At step 102A the processor checks the heterodyned signal for symptoms of early faults, i.e., the peakedness (e.g. zero-peak amplitude compared to a threshold). An important property of frequency distributions is their kurtosis, which refers to their degree of peakedness (broad or narrow) compared to a normal distribution. At the same time, at step 102B, the processor checks the heterodyned signal for symptoms of developed faults, i.e., by checking the signal energy (e.g., the RMS value). The processor than calculates at step 103 the “combined health index” of the signal (e.g., the weighted average or voting). The combined health index can be calculated in many ways and may depend on machine type or monitored frequency range. It may be a simple selection if any of the two inputs is active (then it becomes 1-out-of-2 voting) or if both are active (2 of 2), but it can also be x %/y % of each input. If no faults are detected at steps 102A and 102B, the average is zero. If at step 104 it is determined that no fault is detected, the process goes to step 105 and stops or repeats from the start step 100. Thus, decision block 104 detects existence of a fault.

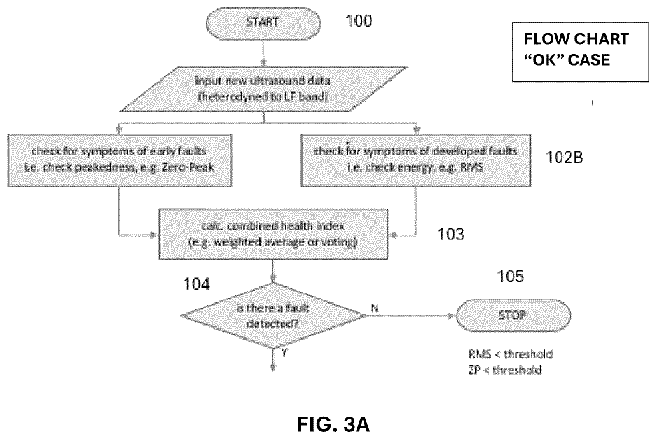

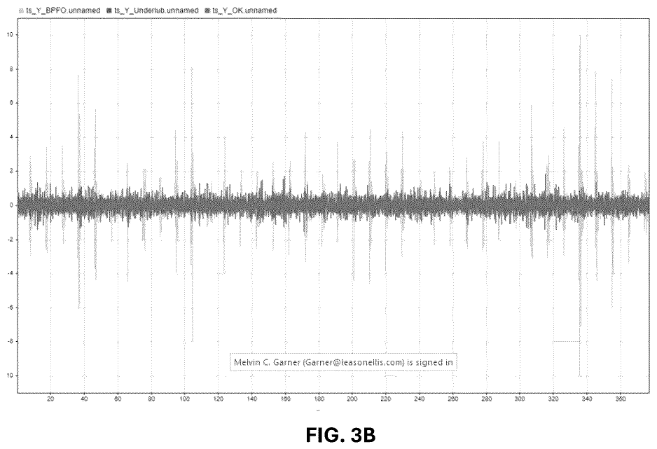

FIG. 3B shows the spectrum of the waveforms for a signal that progresses through steps 100 to 105, i.e., OK data, along with while FIG. 3A shows those steps of the process. The red signal graph is the OK data, and it is presented together with under lubrication data (dark grey) and BPFO, (light grey) data to visualize the proportions. In FIG. 3 the zero-peak and RMS signals are below threshold, so the fault detection and isolation (FDI) algorithm stop at step 105 after the first decision block of step 104.

Returning to FIG. 2, if a fault is detected at decision block 104, the process moves to step 106 where the signal envelope is calculated. Here an appropriate choice is made of the demodulation band depending on the application. Next at step 107 the envelope spectrum is calculated followed by step 108 where the low band of the envelope is extracted, e.g., using a low pass filter. The exact bandwidth depends on the channel frequency (ch_freq) of the monitored assets, e.g., rotatory speed and number of balls of a monitored bearing. It can also depend on the rotary speed, diameter and number of teeth of a gear.

At step 109 the processor calculates the index of repetitiveness, which is the weighted/voted value of the peakedness and energy as described above. At decision block 110 it is determined whether the index of repetitiveness is above a threshold. Thus, the second decision block detects the periodicity of this fault. If the calculation is not above the threshold, the process goes to step 111 which determines that there is a non-periodic fault, e.g., under lubrication, cavitation, etc. The process stops at step 113. However, the results at step 111 can be sent to display 20 for disclosure to the operator. Alternatively, or in addition, the result at step 111 can be used to generate commands, e.g., to turn on lubrication apparatus 22 if available at the bearing.

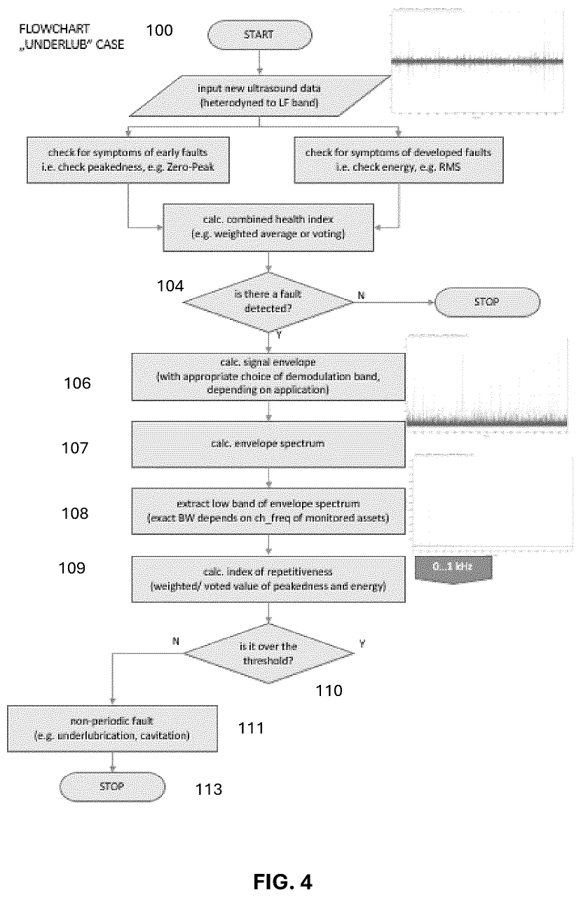

FIG. 4 shows graphs of the waveforms for a signal that progresses from step 100 to step 113, for a signal that indicates that the bearings are under lubricated, i.e., the UNDERLUB data, along with those steps. The UNDERLUB data (red) graph are presented together with the OK data (dark grey) and BPFO (light grey) data to visualize the proportions. In FIG. 4 the ZP and RMS signals are over the threshold, so the FDI algorithm continues after the first decision block at step 104.

In FIG. 4 the signal envelope is larger than for the OK case of FIG. 3, but shows no periodicity, as presented on the envelope spectrum plot. The lower or bottom 1 kHz is used to calculate the envelops of the ZP and RMS signals at 1 kHz, i.e., env_1k_ZP and env_1k_RMS. The lack of periodicity in the signal results in a flat spectrum (in comparison to the BPFO case). Also, the second decision block at step 110 returns FALSE or No, sending the process to step 111 and 113.

Again, returning to FIG. 2, if at the decision block at step 110 it is determined that the index of repetitiveness is above the threshold, the process goes to step 112 where it is declared that a periodic fault exists (e.g., a bearing or gear mechanical fault). The process then proceeds to stop at step 114. This declaration can be sent to display 20 for use by the system operator. Further, the declaration at step 112 can be used to generate a message to a mechanic to replace the bearing or gear on the mechanic's next visit to the machinery by updating the maintenance scheduler 24, or immediately in the case of an imminent critical fault by sending a Wi-Fi or Bluetooth message to the mechanic through signaller 26.

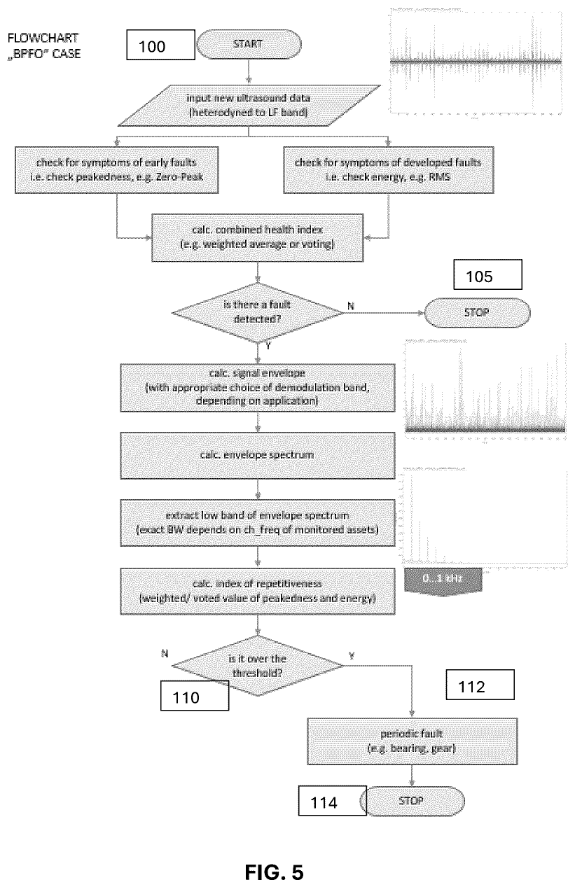

FIG. 5 shows graphs of the waveforms for a signal that progresses from step 100 to step 114, for a signal showing that the bearings have a mechanical fault as indicated by the BPFO data, which are presented in red together with OK (dark grey) data and UNDERLUB (light grey) data to visualize the proportions. The ZP and RMS signals are over the threshold, so the FDI algorithm continues after the first decision block at step 104. The envelope is much larger than for the OK case and shows clear periodicity, as presented on the envelope spectrum plot. The bottom or lower 1 kHz is used to calculate env_1k_ZP and env_1k_RMS. The periodicity results are apparent in a distinct family of harmonics (see comparison with the other two cases). In such a situation the second decision block at step 110 returns TRUE or Yes.

Thus, one advantage of the present invention is that the second check at step 110 is only executed if the first check at step 104 is positive, saving energy and computing time.

During implementation of the system the sampling frequency and buffer lengths may need to be considered along with the efficiency of embedded platforms, where embedded platforms are different types of microcontrollers, as mentioned above Also, the appropriate thresholds need to be set.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A method for distinguishing lubrication faults from mechanical faults in rotary machinery using ultrasound analysis, comprising the steps of
receiving ultrasound signal data from the machinery;
calculating Zero-Peak (ZP) and RMS values of the ultrasound signal data to identify fault presence;
determining if any fault is indicated based on the combined ZP and RMS values being above a threshold;
if the ZP and RMS values are above the threshold, calculating an envelope spectrum of the ultrasound data; and
classifying the fault as a lubrication or mechanical fault based on periodicity indicated within a low-frequency band of the envelope spectrum.

2. The method of claim 1, wherein the classification of the fault as a lubrication fault is based on the absence of periodic harmonics within the low-frequency band of the envelope spectrum.

3. The method of claim 1 wherein the received ultrasound is detected from an ultrasonic transducer placed in the vicinity of a rotating part of the rotating machinery, and the detected signal is heterodyned to a lower frequency.

4. The method of claim 3 wherein the step of determining includes simultaneously checking for peakedness and energy in the heterodyned and combining the ZP and RMS signals to determine a health index signal and determining the existence of a fault when the health index exceeds the predetermined threshold.

5. The method of claim 4 wherein the health index is based on a weighted average or voting of the peakedness and energy signals.

6. The method of claim 4 wherein the classifying step includes extracting a low frequency band of the signal is extracted and calculating an index of repetitiveness, and wherein if the index of repetitiveness exceeds a further predetermined threshold, a determination of mechanical fault is made, otherwise a determination of low lubrication is made.

7. The method of claim 6 wherein the envelope of the health index signal is calculated with appropriate choice of a demodulation band depending on the application.

8. The method of claim 7 wherein the demodulation bandwidth is up to 1 kHz.

9. The method of claim 7 wherein the demodulation bandwidth depends on the rotatory speed and number of balls of a monitored bearing.

10. The method of claim 7 wherein the demodulation bandwidth depends on the rotatory speed, diameter and number of teeth of a monitored gear.

11. A system for distinguishing lubrication faults from mechanical faults in rotary machinery using ultrasound analysis, comprising:
an ultrasonic transducer for receiving ultrasonic signals or data from the rotary machinery;
a heterodyne circuit for lowing the bandwidth of the ultrasonic signal to a lower level;
a processor that classifies the ultrasonic signal as indicating no fault, a lubrication fault or a mechanical fault, said processor being programmed to conduct the steps of;
calculating Zero-Peak and RMS values of the heterodyned signal to identify fault presence;
determining if any fault is indicated based on the combined ZP and RMS values being above a threshold;
calculating an envelope spectrum of the ultrasound data; and
classifying the fault as a lubrication or mechanical fault based on periodicity indicated within a low-frequency band of the envelope spectrum; and
a display that receives the no fault, lubrication or mechanical fault determinations.

12. The system of claim 11 further including within the processor a command generator that issues commands to lubrication apparatus at the machinery to lubricate the rotary machinery.

13. The system of claim 12 wherein the processor issues a command to maintenance scheduling apparatus to put the machine on the schedule to have a part thereof replaced. thereof.

14. The system of claim 12 wherein the processor issues a command to a Wi-Fi signaller to send a message to a mechanic to replace a part of the machinery.
